(19) United States
(12) Patent Application Publication
(10) Pub. No.: US 2017/0348863 A1
(43) Pub. Date: Dec. 7, 2017

(54) KNIFE APPARATUS WITH INTERCHANGEABLE BLADES

(71) Applicant: Browning, Morgan, UT (US)

(72) Inventors: Russ Kommer, Fargo, ND (US); Wenping Zheng, Shanghai (CN); Wuzhi Wu, YangJiang City (CN)

(73) Assignee: Browning, Morgan, UT (US)

(21) Appl. No.: 15/173,344

(22) Filed: Jun. 3, 2016

(51) Int. Cl. B26B 5/00; B26B 9/00

(52) U.S. Cl. CPC B26B 5/00; B26B 9/00

(57) ABSTRACT

Knives configured to use interchangeable blades, blades for those knives, and methods of making an using the knives and blades are disclosed. One knife includes a latch assembly that retains a blade in a slot of the latch assembly using a dual-stage locking mechanism wherein two different latches must be operated to exchange the blade in the slot. One latch is a button that translates a pin through the slot, and the other latch is a rocker lever that rotates into and out of contact with a notch, recess, or groove in the blade. The first latch controls movement of the second latch in order to help avoid inadvertent removal or dislodgement of the blade. Some blades include multiple notches or recesses so that they provide multiple points of contact that resist translation and rotation of the blade out of the slot, even when subjected to unusually-directed forces.

### TECHNICAL FIELD

The present disclosure generally relates to a knife apparatus having interchangeable blades and specifically relates to a knife apparatus with a secure locking letch mechanism for retaining interchangeable blades.

### BACKGROUND

Knives are an indispensable tool for workers and sportsmen across many fields and disciplines. A wide array of different knives are used for different purposes, and their differently sized and shaped blades are usually their most defining features. For outdoor applications, different blades are commonly used for cutting rope and cord, skinning, carving wood, dressing a downed animal, cutting food, and various other activities. Each blade may be especially suited for each task to maximize efficiency and preserve blade life.

However, the advantages of the specialization of each blade are counterbalanced by the disadvantages of needing different knives to perform different tasks. Having to carry and keep track of multiple knives can be space- and time-consuming. For outdoorsmen, the weight of carrying many knives in a pack can also be burdensome.

Therefore, knives have been developed that have interchangeable blades. With these kinds of knives, the user may use a particular blade for one specialized function and then remove the blade from a blade holder on the knife and exchange it for a blade or tool used for another function. These knives are also popular when used with utility razor blades that are used and then discarded when the blade dulls.

Although interchangeable-blade knives are easier to transport than multiple knives for different tasks, they also tend to be less reliable than single-purpose knives. The interchangeable blade retaining mechanisms can be loose in holding the blades, particularly when the blade is subjected to extreme force or unusual loading conditions. Blades that can potentially disconnect from the blade holders interfere with blade usage and can promote breakage of the blades and their holding mechanisms. Accordingly, there is a need for improvements to interchangeable-blade knives.

### SUMMARY

One aspect of the present disclosure relates to a knife having an interchangeable blade. The knife may comprise a handle, a latch assembly connected to the handle, and a blade. The latch assembly may comprise a slot and a rocker positioned in the slot, with the rocker being rotatable within the slot between a first rocker position and a second rocker position and with the second rocker position being rotated relative to the first rocker position. The latch assembly may also comprise a rocker locking member extending across the slot, with the rocker locking member being movable between a locked position preventing rotation of the rocker between the first and second rocker positions and an unlocked position permitting rotation of the rocker between the first and second rocker positions. The blade may comprise a proximal end positioned in the slot and a back edge having a notch, with the rocker being positioned in the notch when the rocker is in the first rocker position, the blade being prevented from removal from the slot when the rocker is in the first rocker position, and the blade being removable from the slot when the rocker is in the second rocker position.

In some embodiments the latch assembly and blade are foldable into the handle. The rocker locking member may be a button and may be biased to the first rocker position by a compliant member. The rocker locking member may also comprise a first diameter portion and a second diameter portion, with the first diameter portion being aligned with the rocker in the slot when the rocker locking member is in the locked position and with the second diameter portion being aligned with the rocker in the slot when the rocker locking member is in the unlocked position. In that case, the first diameter portion may have a greater diameter than the second diameter portion. The rocker locking member may also be positioned on a thumbstud.

The rocker may comprise a pivot point in the slot that is positioned distal to the rocker locking member. The blade may further comprise a longitudinally-extending notch, and the latch assembly may further comprise a retaining member in the slot with the retaining member being positioned in the longitudinally-extending notch of the blade. The blade may further comprise a hook portion and the latch assembly may comprise a retention plate, with the hook extending around at least two sides of the retention plate. In some arrangements, the proximal end of the blade has a trapezoidal shape and the latch assembly has a trapezoidal hollow, with the trapezoidal shape being fitted into the trapezoidal hollow.

Another aspect of the disclosure relates to a knife having a removable blade and dual-stage locking mechanism. The knife may comprise a handle, a latch assembly, and a blade. The latch assembly may comprise a slot, a first latch, and a second latch, with the first latch being translatable relative to the slot and with the second latch being rotatable relative to the slot. A blade may be retained in the slot, with the blade being removable from the slot upon sequential actuation the first latch followed by the second latch.

In some configurations, the first latch may lock the position of the second latch. The second latch may also retain the blade in the slot. The first latch may be a biased pin extending through the slot. The second latch may be a rocker at least partially positioned in a notch in the blade.

Yet another aspect of the disclosure relates to a method of securing an interchangeable blade to a knife handle, wherein the method may comprise providing a knife, with the knife having a handle, a latch assembly, and a blade. The latch assembly may be connected to the handle, and the latch assembly may comprise a slot in which the blade is positioned. The latch assembly may also comprise a rocker and a rocker locking member, with the rocker retaining the blade in the slot. The method may further comprise actuating the rocker locking member to unlock the rocker relative to the blade, rocking the rocker away from the blade while actuating the rocker locking member, and removing the blade from the slot.

In some embodiments, actuating the rocker locking member may comprise pushing the rocker locking member laterally and at least partially through the slot. The method may also include inserting a second blade into the slot while rocking the rocker, rotating the rocker toward the second blade while actuating the rocker locking member, and deactuating the rocker locking member to lock the rocker relative to the second blade.

Still another aspect of the disclosure relates to an interchangeable blade for a knife, with the interchangeable blade comprising a lateral face, a belly edge, and a spine edge. The spine edge may be positioned opposite the belly edge. A first recess may be recessed into the spine edge in a first direction and a second recess may be recessed into the spine edge in a second direction, with the first direction being positioned non-parallel to the second direction.

In some arrangements, the first direction may extend toward the belly edge. The blade may also further comprise a heel portion comprising a rear edge and the belly edge may comprise a heel edge at the heel portion. The heel edge may extend at an acute angle relative to the rear edge. The spine edge may comprise a protrusion extending at least partially around the second recess. In some embodiments, the second direction may be parallel to a major longitudinal axis of the interchangeable blade and the first direction may be perpendicular to the second direction. The belly edge may comprise a sharpened gut hook blade.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1A is a perspective view of a knife according to an embodiment of the present disclosure.

FIG. 1B is a perspective view of the knife of FIG. 1A with the blade removed.

FIG. 2 is a perspective view of the knife of FIG. 1A in a folded configuration.

FIG. 3 is a side view of an interchangeable blade according to an embodiment of the present disclosure.

FIG. 4A is a section view of a latch assembly according to an embodiment of the present disclosure.

FIG. 4B is a section view of the latch assembly of FIG. 4A with a blade inserted.

FIG. 4C is a section view of the latch assembly of FIG. 4B with a rocker rotated.

FIG. 5A is a section view of the latch assembly of FIG. 4A taken through section lines 5A-5A shown in FIG. 4A.

FIG. 5B is a section view of the latch assembly of FIG. 4B taken through section lines 5B-5B shown in FIG. 4B.

FIG. 5C is a section view of the latch assembly of FIG. 4C taken through section lines 5C-5C shown in FIG. 4C.

FIGS. 6A-6C show side views of interchangeable tools according to embodiments of the present disclosure.

FIG. 7 shows a section view of a latch assembly with a blade inserted.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to a knife apparatus having a secured interchangeable blade or other interchangeable tool. The knife may comprise a handle and a latch assembly. A blade may be positioned in a slot in the latch assembly and may be held in place in the slot by a rocker that is also positioned in the slot. The blade may also be held in the slot by a pin that is positioned within a hook-shaped or curled portion of the blade. The rocker may comprise a lever that is retained in place by a spring and a button that is operable as a thumbstud. When the blade is in use, the button may prevent the rocker from being inadvertently pivoted, and the blade therefore remains locked securely in place by a portion of the rocker. When the blade needs to be removed or exchanged, the button may be depressed and the rocker may be able to pivot into a space where a portion of the button was previously blocking the movement of the rocker. Accordingly, while the button is depressed, the rocker may be pivoted out of the way of the blade, and the blade may be easily removed and exchanged.

The rocker (i.e., lock back lever) may have a pushing side and a blade engagement side separated by a pivot point. The pushing side may be at the proximal end of the rocker and may be biased in a generally upward direction by a torsion spring. In its resting position, the torsion spring may be extended and the pushing side of the lever may be in a raised position generally aligned with the back edge of the blade holder (i.e., latch assembly). In this position, the blade engagement side of the lever may be held in a downward position at its distal end where it is configured to engage with an interchangeable blade. To actuate the lever, a user may press on the pushing side of the rocker. Since the lever is pivotally connected to the blade holder, depressing the pushing side may cause the blade engagement side to move away from a notch in the blade. However, the presence of the secondary lock button or pin prevents a user from being able to depress the pushing side of the rocker unless the lock button is simultaneously pressed. The secondary lock button may also be spring loaded. In its resting position, a thicker section of the lock button lies under the pushing side of the lever and prevents the lever from being depressed. In other words, the thicker section of the lock button serves as an obstruction to rotation of the lever. However, the secondary lock button may also include a narrow section, and when the lock button is depressed, the narrow section may align with the lever. Accordingly, when the narrow section is so aligned, the pushing side of the lever may rotate into a space created within the blade holder due to the thicker section of the lock button moving out of the way of the lever.

In operation, to change blades out, a user may depress the secondary lock button and then depress the pushing side of the lever. The extra space in the blade holder that is provided by the narrow section on the lock button may then allow the pushing side of the lever to rotate and drop, thereby raising the blade engagement side of the lever and releasing the blade. Once the blade engagement side of the lever is raised, a user can easily extract the blade from the blade holder. The inclusion of the secondary lock button may therefore prevent the inadvertent release of the blade by pressing the lever alone.

The reverse actions may be used to insert a new blade into the blade holder. Namely, a user may depress the pushing side of the lock lever while simultaneously pushing the secondary lock button. This aligns the narrow section of the secondary lock button with the lock back lever so that the pushing side of the lever has room to pivot and raise the blade engagement side of the lever. A user can then insert a new blade into the blade holder and release the lock back lever (which, because of the torsion spring, will return to its resting position) and the secondary lock button (which also, because it is spring loaded, will return to its resting position). The blade is thereby secured in place.

These features may strengthen the retaining mechanism of the knife apparatuses of the present disclosure by ensuring that the interchangeable blade or other tool contacts four or more differently-facing surfaces of the blade. Thus, the blade may be subjected to unusual loading patterns and forces applied from many different directions without being dislodged from the retaining mechanism. Additionally, the latch assembly may be implemented in folding or fixed-blade knives and with a wide variety of different blade and tool sizes and types, including, for example, utility razor blades and gut hooks.

As used herein, a “proximal” portion of a blade or tool connected to a knife is the part of the blade or tool that is closest to the handle, and a “distal” portion of a blade or tool is the part of the blade that is farthest from the handle. Thus, a proximal direction is a direction parallel to a longitudinal axis of the blade and/or handle and extends from a middle portion of the blade toward the handle. A distal direction is a direction parallel to the longitudinal axis of the blade and/or handle and extends away from a middle portion of the blade away from the handle.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

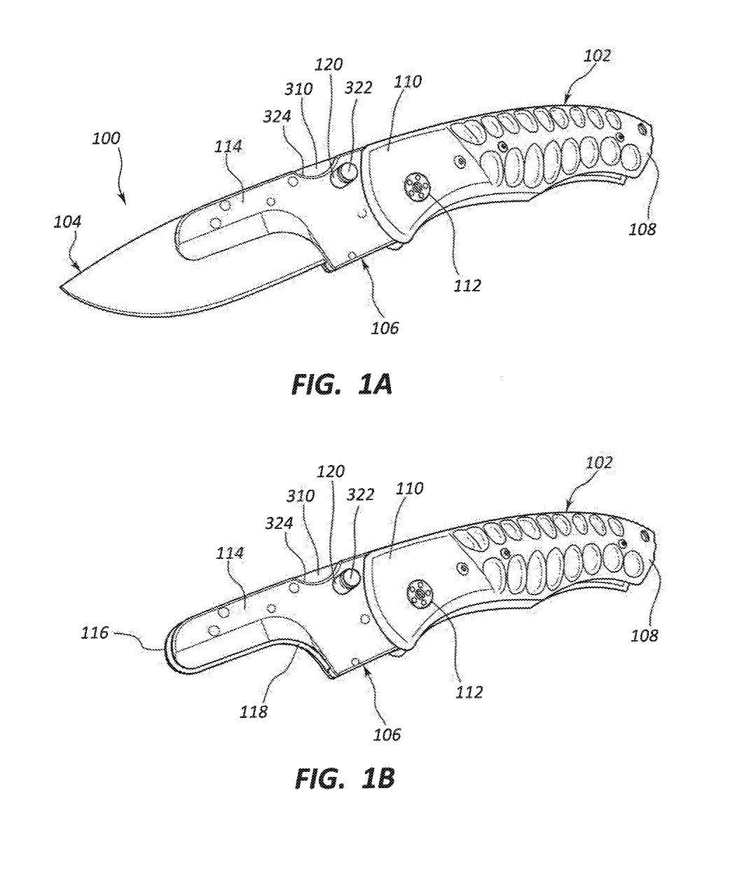

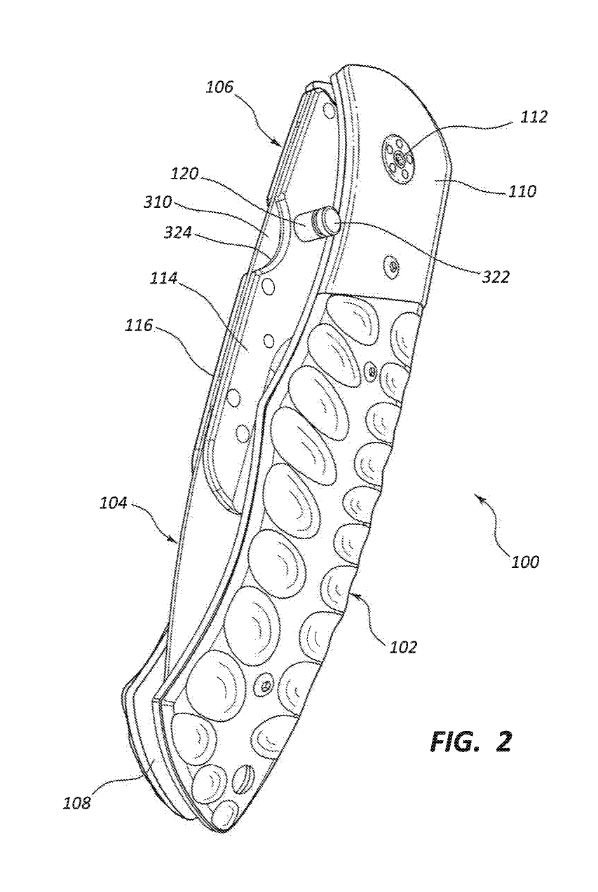

Turning now to the figures in detail, FIGS. 1A-2 show a knife 100 according to an embodiment of the present disclosure. The knife 100 may comprise a handle 102, a blade 104, and a latch assembly 106. FIG. 1A shows the knife 100 unfolded, FIG. 1B shows the knife 100 unfolded with the blade 104 removed, and FIG. 2 shows the knife 100 folded with a blade 104 attached.

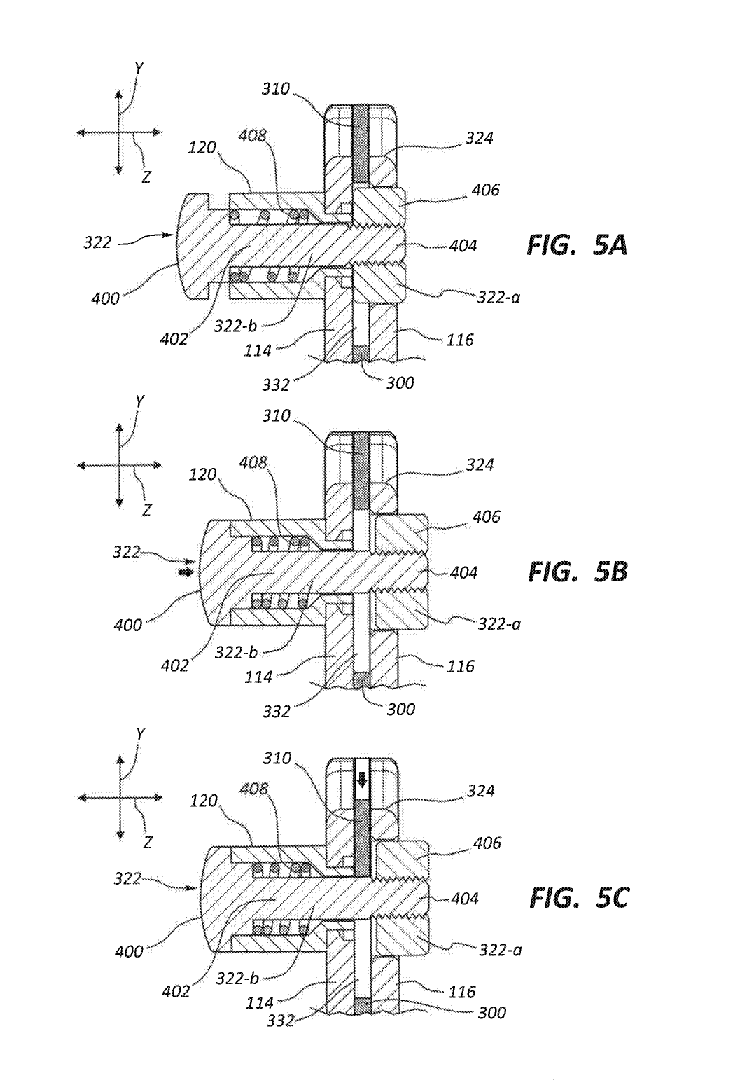

The handle 102 may comprise a pommel end 108 and a pivot end 110. The pivot end 110 may comprise a pivot pin 112 that extends through the pivot end 110 and through the latch assembly 106. Using the pivot pin 112, the latch assembly 106 may pivot between the unfolded positions of FIGS. 1A-1B and the folded position of FIG. 2. The latch assembly 106 may comprise a first side plate 114 and a second side plate 116. A slot 118 may be positioned between the first and second side plates 114, 116. See FIG. 1B. The blade 104 may be positioned and removably retained in the slot 118 between the first and second side plates 114, 116. A thumbstud 120 may be provided to facilitate folding and unfolding the blade 104 and latch assembly 106. In some embodiments, a thumbstud 120 may be omitted, wherein the lock pin 322 may be shortened to have its button portion 400 closer to the first side plate 114. See also FIGS. 5A-5C.

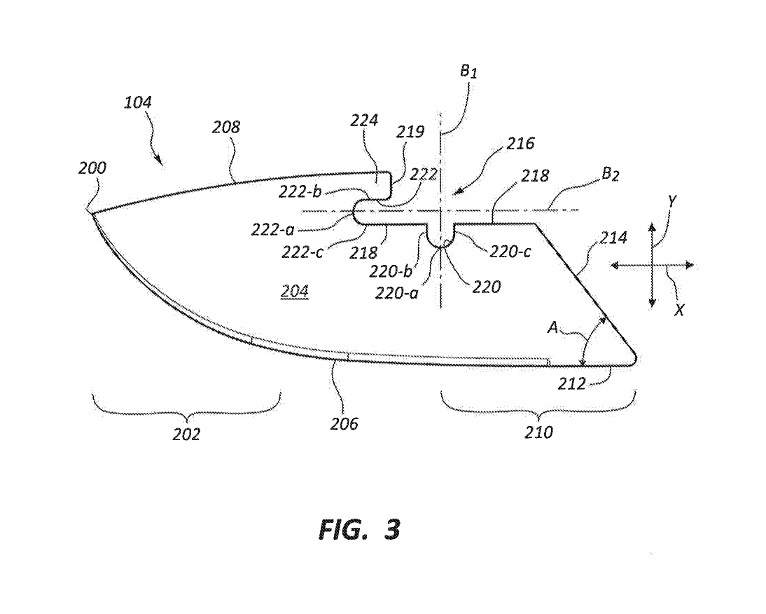

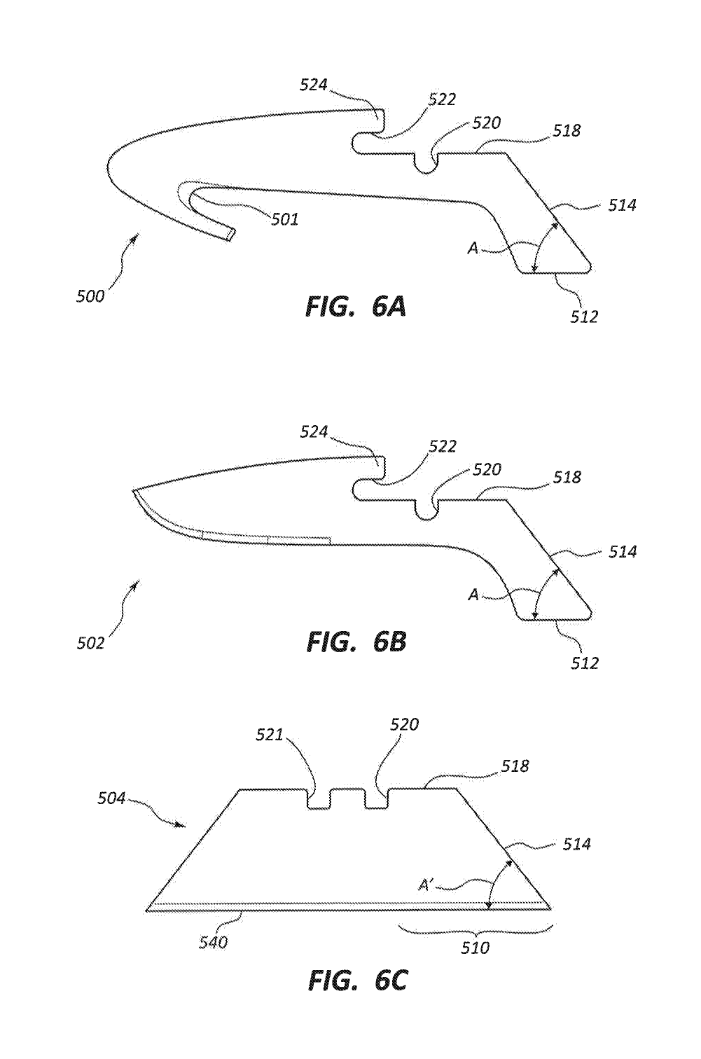

FIG. 3 shows a blade 104 separated from the latch assembly 106 and handle 102. The blade 104 shown in FIG. 3 is a single-edged blade, but other types of blades and tools may be used. See also FIGS. 6A-6C. Thus, the blade 104 shown is intended as an example illustrating one type of device that is possible to connect to the latch assembly 106. The blade 104 may comprise a distal point 200, a tip 202, a cheek 204, a sharpened edge 206 (i.e., belly edge), a blade spine 208 (i.e., the blade back at the tip 202), a heel 210, a dull edge 212, a rear edge 214, and a latching portion 216. The cheek 204 of the blade 104 is the side face of the blade 104. It may comprise a flat, broad surface in comparison to the back or spine of the blade 104. In some embodiments, the cheek 204 may comprise a grind or beveled surface. The grind or beveled surface may be part of the cheek 204. A perpendicular plane extending through the cheek 204 may divide the blade 104 in a longitudinal direction between the dull edge 212 and the blade spine 208 (or latch spine 218). In various embodiments, the sharpened edge 206 may not be sharpened, such as in a blade 104 that functions as a crescent wrench or can opener. The sharpened edge 206 may also comprise serrations, may be entirely straight instead of belly-shaped, or may have other irregular shapes. Thus, the sharpened edge 106 may be alternatively referred to as any edge opposite the spine 208/218 of the blade 104 relative to the cheek 204, whether or not that edge is sharp and straight.

The latching portion 216 may comprise a latch spine 218, a spine notch 220, and a longitudinal notch 222. The longitudinal notch 222 may be formed in part by the latch spine 218 and in part by a retention hook portion 224 that extends proximally from the blade spine 208 and is dorsally spaced from the latch spine 218. The blade spine 208 may also be spaced dorsally away from the latch spine 218 (i.e., the latch spine 218 may be ventrally spaced from the blade spine 208). For convenient reference in describing the features of the knife 100, a dorsal direction extends upward along the Y-direction, and a ventral direction extends downward along the Y-direction.

The spine notch 220 and the longitudinal notch 222 may extend into the blade 104 in different, perpendicular directions. The spine notch 220 may be recessed vertically downward into the latch spine 218 along axis B₁, and the longitudinal notch 222 may extend into the blade along a longitudinal direction that is perpendicular to the downward direction, i.e., along axis B₂. The longitudinal direction may be along the major axis of the blade 104 and parallel to the X-direction in FIG. 3.

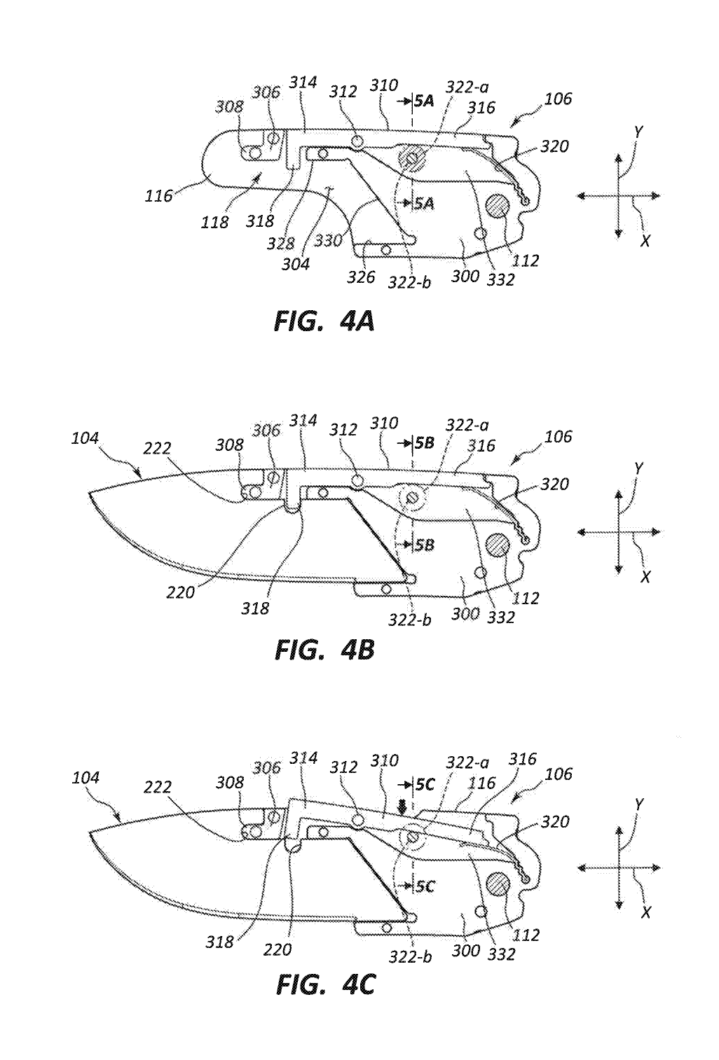

The retention hook portion 224 may be positioned at a location that is at about the midpoint of the blade 104. Thus, the heel 210 and the tip 202 may be longitudinally positioned on each side of the retention hook portion 224. The retention hook portion 224 may beneficially be positioned at or near the center of the blade 104 along the longitudinal axis/major axis of the blade 104 so that when forces are applied to the blade 104 that pull the tip 202 of the blade downward relative to the heel 210, the retention hook portion 224 may provide an anchor point for the blade 104 against the latch assembly 106. Specifically, contact between the retention hook portion 224 and at least two sides of the retainer plate 306 (see, e.g., the dorsal and ventral sides of the retainer plate 306 in FIG. 4B) may prevent the blade 104 from being dislodged from the latch assembly 106 if the tip 202 is rotated downward relative to the heel 210 since the anchor point is closer to the tip 202 than to the heel 210. This feature may be beneficial when a gut hook tool 500 (see FIG. 6A) is used since pulling on a sharpened gut hook blade 501 may apply downward stress on the tip that would be unusual for other cutting blades (e.g., blade 104 or tools 502, 504). See also FIGS. 6A-6C.

The spine notch 220 may be referred to as a recess in the latch spine 218 (or spine edge) of the blade 104. The spine notch 220 may be generally U-shaped with a curved, semicircular end surface 220-a and parallel side surfaces 220-b, 220-c. The longitudinal notch 222 may also be referred to as a recess in the spine edge of the blade 104, wherein the spine edge includes a back edge 219 of the retention hook portion 224 and the latch spine 218. Alternatively, the longitudinal notch 222 may be referred to as a recess extending longitudinally into the back edge 219 of the retention hook portion 224.

The longitudinal notch 222 may be generally U-shaped with a curved, semicircular end surface 222-a and parallel side surfaces 222-b, 222-c. One of the side surfaces 222-c may be coincident with and/or an extension of the latch spine 218. The side surfaces 222-b, 222-c of the longitudinal notch 222 may be parallel to the longitudinal axis of the blade 104 (e.g., parallel to the X-direction), and the side surfaces 220-b, 220-c of the spine notch 220 may be perpendicular to the longitudinal axis of the blade 104. Thus, the direction that the spine notch 220 or longitudinal notch 222 extends into the blade 104 may be defined as the direction parallel to their respective side surfaces 220-b, 220-c or 222-b, 222-c. Alternatively, the direction that the spine notch 220 or longitudinal notch 222 extends into the blade 104 may be defined as being along an axis that bisects the notch 220, 222, such as, for example, axis B₁ or axis B₂ in FIG. 3. In yet another example embodiment, the direction that a notch extends into the blade 104 may be defined as being along an axis that extends through a centroid of the notch and its most recessed end surface. Axes B₁ and B₂ would also meet this requirement for notches 220 and 222, respectively.

The end surface of a recess or notch may be defined as the portion of the recess that is most recessed relative to the immediately adjacent portions of the edge from which the side surfaces of the recess or notch extends. In the case of spine notch 220, the end surface 220-a is the end surface since it is most recessed relative to each portion of the latch spine 218 that connects to the side surfaces 220-b, 220-c. Likewise, the end surface 222-a of longitudinal notch 222 is the end surface since it is most recessed relative to the portion of the latch spine 218 and the back edge 219 that connect to side surfaces 222-b, 222-c. The back edge 219 of the retention hook portion 224 may be oriented perpendicular to the spine edge 218 and perpendicular to the blade spine 208, at least where the blade spine 208 is immediately adjacent to the back edge 219.

In some embodiments, at least one of the spine notch 220 and the longitudinal notch 222 may be a square recess, wherein the end surface 220-a or 222-a has a square or rectangular shape rather than a semicircular shape. Similarly, the spine notch 220 and longitudinal notch 222 may have hexagonal, octagonal, trapezoidal, or other polygonal recessed shapes. Each of the spine notch 220 and the longitudinal notch 222 may have boundaries in three directions that are defined by the blade 104. For example, the spine notch 220 has its boundaries defined by three surfaces: end surface 220-a and each side surface 220-b, 200-c. In other embodiments, the spine notch 220 may have its boundaries defined by two surfaces (i.e., a V-shaped notch). In that case, the spine notch 220 would still have boundaries in three directions since the sides of the V-shape would define sidewalls in two opposing directions and the point where the two sides of the V-shape intersect would define a sidewall in another direction that is perpendicular to the two opposing directions. Similarly, the longitudinal notch 222 may be referred to as having boundaries in three directions since a pair of axes that perpendicularly intersect within the longitudinal notch 222 would separately intersect each of three surfaces 222-a, 222-b, 222-c. The same pair of axes, if positioned in the spine notch 220, would also intersect three surfaces 220-a, 220-b, 200-c.

FIG. 4A shows a view of the latch assembly 106 with the first side plate 114 removed to expose the internal components of the latch assembly 106. Thus, the interior of the slot 118 is also shown. A core plate 300 may be positioned between the first and second side plates 114, 116. Thus, the pivot pin 112 may extend through the first and second side plates 114, 116 and the core plate 300. The first and second side plates 114, 116 and core plate 300 may be connected to each other, such as by a plurality of fasteners (e.g., rivets), a welding, adhesive, or other fastening method providing a secure fit of the plates to each other.

The slot 118 in the latch assembly 106 may be formed on lateral sides by the first and second side plates 114, 116 and on its rear, top, and bottom sides by the core plate 300. Thus, the slot 118 may include a forward blade retention void 304, as shown in FIG. 4A. The blade 104 may be inserted into and releasably retained within the forward blade retention void 304, as shown in FIGS. 4B and 4C.

The latch assembly 106 may also comprise a retainer plate 306 positioned forward of the core plate 300 between the first and second side plates 114, 116. The retainer plate 306 may also be attached to the first and second side plates 114, 116 in a manner similar to the connection between the core plate 300 and the first and second side plates 114, 116. The retainer plate 306 may comprise a pin portion 308 that extends longitudinally within the slot 118 (i.e., it may extend along the X-direction shown in FIGS. 4A-4C).

A rocker 310 may be positioned in the slot 118 rearward of the retainer plate 306. The rocker 310 may be alternatively referred to as a lever or pivotable member because it is pivotable around a rocker pivot pin 312. The rocker 310 may comprise a forward end 314 and a rearward end 316 that are divided from each other by the rocker pivot pin 312. The forward end 314 may comprise a latch hook 318 or protrusion. The rearward end 316 may contact a rocker biasing member 320 attached to the core plate 300 and may, in certain configurations, contact a lock pin 322 extending through the thumbstud 120.

The lock pin 322 may be laterally movable in a perpendicular direction (i.e., parallel to axis Z in FIGS. 5A-5C) through the core plate 300 and first and second side plates 114, 116. In other words, the lock pin 322 may be translatable through the core plate 300 and first and second side plates 114, 116 since it can translate relative to those plates. In a first position, the lock pin 322 may have a first diameter aligned with the rocker 310 that is a first size, as shown by lock pin portion 322-a. See FIGS. 4A and 5A. In a second position, the lock pin 322 may have a second diameter aligned with the rocker 310 that is a second, smaller size, as shown by lock pin portion 322-b. See FIGS. 4B and 5B; see also FIGS. 5A-5C and their related descriptions below.

At a rest position, the rocker 310 may be positioned as shown in FIGS. 4A and 4B. The major longitudinal axis of the rocker 310 extending between the forward and rearward ends 314, 316 may be substantially parallel to the longitudinal axis of the latch assembly 106 (i.e., parallel to axis X). The rocker 310 may be biased into the rest position by the rocker biasing member 320 contacting the underside of the rearward end 316 of the rocker 310. Thus, the rocker biasing member 320 may apply a vertically-upward-oriented force (i.e., parallel to axis Y) to the rearward end 316 of the rocker 310. As a result, the rocker 310 may be biased to rotate counter-clockwise around the rocker pivot pin 312, thereby driving the forward end 314 of the rocker 310 downward toward the blade 104. The latch hook 318 is therefore rotated to a rest position oriented substantially parallel to the Y-direction and perpendicular to the pin portion 308 of the retainer plate 306 when in the rest position.

As shown in FIG. 4B, the blade 104 may be positioned in the blade retention void 304 in the slot 118 when the rocker 310 is in the rest position. The blade 104 may be securely held in the slot 118 due to multiple points of interfering surface contact between the latch assembly 106 and the blade 104. With reference to FIGS. 3, 4A, and 4B, the pin portion 308 of the retainer plate 306 may be positioned within the longitudinal notch 222 of the blade 104. Downwardly-directed movement of the blade 104 relative to the slot 118 (i.e., downward movement along the Y-direction in FIG. 4B) may be prevented by contact between the retention hook portion 224 and the upper side of the retainer plate 306 and/or contact between the dull edge 212 of the blade 104 and a ventral support surface 326 on the core plate 300. Upwardly-directed movement of the blade 104 relative to the slot 118 may be prevented by contact between the latch spine 218 and the retainer plate 306, contact between the latch spine 218 and a latch spine support surface 328 on the core plate 300 (see FIG. 4A), and/or contact between the rear edge 214 and a rear edge support surface 330 on the core plate 300 (see FIG. 4A). Inwardly- or proximally-directed movement of the blade 104 relative to the slot 118 (i.e., to the right along the X-direction in FIG. 4B) may be prevented by contact between the rear edge 214 and the rear edge support surface 330, contact between the longitudinal notch 222 and retention hook portion 224, and/or contact between spine notch 220 and the latch hook 318. Outwardly- or distally-directed movement of the blade 104 relative to the slot 118 (i.e., to the right along the X-direction) may be prevented by contact between the spine notch 220 and the latch hook 318. Accordingly, the blade 104 may be secured in the slot 118 in four directions along the X-Y plane (i.e., a plane between the cheeks 204 of the blade 104). The blade 104 may also be held in place in the lateral directions by contact with the inner surfaces of the first and second side plates 114, 116. This all-around contact between the blade 104 and the latch assembly 106 may help prevent the blade from dislodging while in use.

The dull edge 212, rear edge 214, and rear portion of the latch spine 218 may collectively be part of the heel 210 of the blade 104 and may collectively form a trapezoidal shape, wherein the dull edge 212 and portions of the sharpened edge 206 may form one side of the trapezoidal shape, and those edges 206, 212 may be parallel to the latch spine 218, which forms another side of the trapezoidal shape. The rear edge 214 forms a non-parallel side of the trapezoidal shape since it extends along angle A relative to the dull edge 212 (see FIG. 3). A corresponding trapezoidal-shaped hollow is formed in the slot 118 by the core plate 300. As shown in FIG. 4A, the ventral support surface 326, latch spine support surface 328, and rear edge support surface 330 form a trapezoidal-shaped hollow. The rear edge support surface 330 may extend from the ventral support surface 326 at angle A as well. The trapezoidal shape of the heel 210 of the blade 104 may have a shape closely fitting into the correspondingly-sized trapezoidal-shaped hollow of the core plate 300. For example, the heel 210 may contact the ventral support surface 326, latch spine support surface 328, and rear edge support surface 330 simultaneously.

The blade 104 may also be secured against rotating out of the slot 118 by the various points of contact with the latch assembly 106 described above. For example, a counter-clockwise moment applied to the blade 104 (e.g., by a force applied downward at the tip 202 of the blade 104) may be prevented from rotating the blade 104 out of the slot 118 due to the blade 104 having at least two coordinating contact points with the latch assembly 106. In this example, the contact points may be the contact between the retention hook portion 224 and the retainer plate 306 and the contact between the rear edge 214 and the rear edge support surface 330 of the core plate 300. These coordinating contact points may apply a resultant moment to the blade 104 that prevents rotational movement relative to the latch assembly 106, thereby holding the blade 104 in place while it is in use. Similarly, a clockwise moment applied to the blade 104 may be prevented from rotating the blade 104 relative to the slot 118 due to coordinating contact points between the blade 104 and latch assembly 106. For example, a first contact point may be between the dull edge 212 of the blade 104 and the ventral support surface 326, and a second contact point may be between the latch spine 218 and the retainer plate 306 or the latch spine support surface 328.

The blade 104 may be released from the latch assembly 106 when desired. Pressure may be applied to the spine of the rocker 310 at a detent 324 in the latch assembly 106 (see FIGS. 1A-2), and the force applied to the rocker 310 may overcome the biasing force applied by the rocker biasing member 320 to cause the rocker 310 to rotate, as shown in FIG. 4C. When the rocker 310 is rotated away from the blade 104, the latch hook 318 may be rotated away from the spine notch 220. Accordingly, the latch hook 318 may be moved clear of the blade 104, and the blade 104 may therefore no longer have any interfering contact with that latch assembly 106 that would prevent the blade 104 from being drawn longitudinally and distally (i.e., along the X-direction) out of the slot 118. After removal of the blade 104, the force on the rocker 310 at the detent 324 may be removed, and the rocker 310 may be biased back into the position shown in FIG. 4A.

In order to help avoid inadvertent or unintentional removal of the blade 104 from the latch assembly 106, the front end 314 of the rocker 310 may be prevented from rotating away from the blade 104 under normal use of the knife 100, even if a force is applied to the rocker 310 at the detent 324 during use. FIGS. 5A-5C illustrate how the lock pin 322 (i.e., rocker locking member) may be used to control movement of the rocker 310. FIGS. 5A-5C illustrate section views through the lock pin 322, thumbstud 120, and detent 324 of the latch assembly 106.

The lock pin 322 may extend through the thumbstud 120 and the first and second side plates 114, 116. The lock pin 322 may comprise a button portion 400 that extends out of the thumbstud 120. The lock pin 322 may also comprise a shaft 402 with a threaded portion 404 and a nut 406 on the threaded portion 404. The lock pin 322 may therefore comprise a lock pin portion 322-a having a first diameter (i.e., the diameter of nut 406) and a lock pin portion 322-b having a second diameter (i.e., the diameter of shaft 402). The first diameter may be larger than the second diameter and may be located on an external end of the lock pin 322 (i.e., the end with threaded portion 404) relative to the second diameter. In some embodiments, the lock pin 322 may comprise a single integral piece, wherein the shaft 402 and nut 406 are formed as a single monolithic piece or are welded or adhered to each other.

The shaft 402 and nut 406 may be biased to a rest position shown in FIG. 5A by a pin biasing member 408 within the thumbstud 120. The pin biasing member 408 may be a coil spring that contacts an inner surface of the button portion 400 of the lock pin 322 and an inner surface of the thumbstud 120. In the rest position, the nut 406 is at least partially positioned in a rocker slot 332 between the first and second side plates 114, 116, and the rocker 310 is positioned adjacent to and above the nut 406 in the rocker slot 332. The slot 118 and rocker slot 332 may collectively be part of an overall slot between the first and second side plates 114, 116 in which the core plate 300 and retainer plate 306 are also positioned.

With the lock pin 322 in the rest position, when the rocker 310 is pressed downward at the detent 324, the rocker 310 rotates into contact with the outer surface of the nut 406 and is therefore prevented from rotating very far (if at all) within the rocker slot 332. The nut 406 interferes with the rotation, and the rocker 310 is therefore unable to rotate sufficiently to move from the position shown in FIG. 4B to the position shown in FIG. 4C or from the position shown in FIG. 5A to the position shown in FIG. 5C. As a result, the latch hook 318 may be prevented from moving out of the spine notch 220 of the blade 104, so the blade remains secured by the rocker 310.

The lock pin 322 may be pressed toward the first side plate 114 by applying a lateral force to the button portion 400, as shown in FIG. 5B. When the lock pin 322 is pressed inward, the pin biasing member 408 may compress and the nut 406 may move out of the rocker slot 332. The shaft 402 of the lock pin 322 may therefore be exposed to the rocker slot 332. Because the shaft 402 has a smaller diameter than the nut 406, the rocker 310 may no longer be as inhibited from rotation within the rocker slot 332 due to contact with the outer diameter of the lock pin 322. Accordingly, if the lock pin 322 is pressed inward, the rocker 310 may simultaneously be rotated around the rocker pivot pin 312, as shown in FIGS. 4C and 5C. The rocker 310 may rotate downward along the Y-direction between the thumbstud 120 and the nut 406, and in that position it has rotated far enough to be able to rotate the latch hook 318 out of the spine notch 220, thereby releasing the blade 104.

The latch assembly 106 may be referred to as having a dual-locking or two-step sequential latch since the lock pin 322 and rocker 310 may both need to be manipulated in sequence in order for the latch hook 318 to release the blade 104. The lock pin 322 and rocker 310 may also be operated to insert a blade 104 into the slot 118. In other words, the latch hook 318 may prevent insertion of a blade 104 until the latch hook 318 is pivoted out of the way of the blade 104. The lock pin 322 may need to be simultaneously actuated with the rocker 310 for the locking mechanism to allow insertion or removal of the blade 104. In other words, the lock pin 322 may need to remain actuated while the rocker 310 is actuated, even though the lock pin 322 should be actuated sequentially prior to actuation of the rocker 310.

Because the blade 104 may be interchangeable, a variety of blades or other tools may be used and retained in the slot 118. FIGS. 6A-6C show some examples of other tools 500, 502, 504 that may be used in place of blade 104. Tool 500 is a gut hook, tool 502 is a narrow blade, and tool 504 is a utility blade/razor blade. These tools 500, 502, 504 may each comprise a rear edge 514 and a latch spine 518 having a spine notch 520. Tools 500 and 502 may also comprise a longitudinal notch 522, a retention hook portion 524, and a dull edge 512. Tool 500 may comprise a recessed hook-shaped cutting surface 501, and tool 504 may comprise a sharpened edge 540 in the heel 510 area.

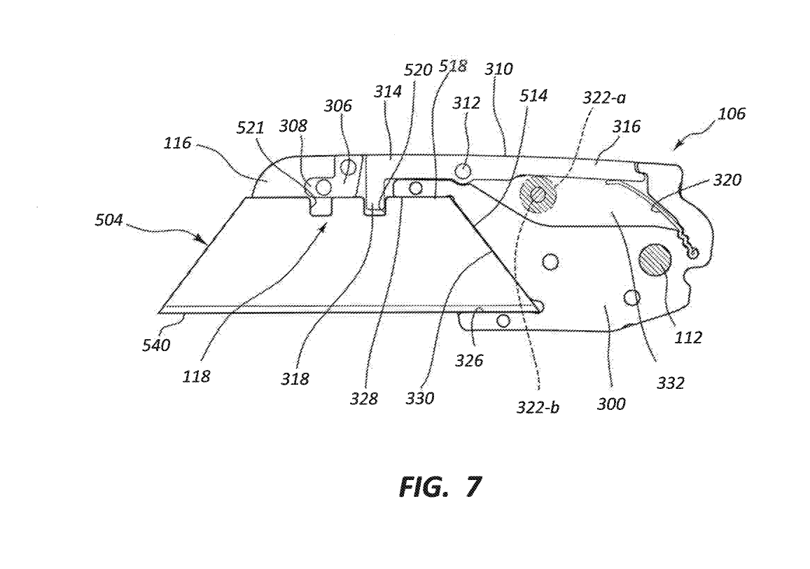

Accordingly, when the tools 500, 502 are inserted into the slot 118 of a latch assembly 106, they may fit in the same manner as the blade 104. When tool 504 is inserted into the slot 118, it may not engage the top surface of retainer plate 306, but may engage the bottom surface of the retainer plate 306 and the latch hook 318. FIG. 7 shows the tool 504 held in the latch assembly 106. Tool 504 may also be reversibly insertable into the slot 118, wherein either end of the tool 504 may be inserted into the slot 118 with the other end extending outward. The other tools 500, 502 and blade 104 may only have one orientation in which they may be retained in the slot 118. Tool 504 may comprise two spine notches 520, 521 that facilitate its reversibility. Thus, either of the spine notches 520, 521 may be engaged with the latch hook 318, depending on which end of the tool 504 is inserted into the latch assembly 106. In some arrangements, tool 504 may be a conventional utility razor blade. Thus, the knife 100 may use conventional utility razor blades in addition to other tools. The blade 104 and tools 500, 502 may each have a heel angle A equivalent to an end angle A′ of a conventional utility razor blade. See FIGS. 3 and 6A-6C.

Some aspects of the present disclosure relate to methods for making and using a knife having an interchangeable blade and a latch assembly. One method may include providing the knife (e.g., knife 100), actuating a rocker locking member (e.g., 322) to unlock a rocker (e.g., 310) or lever relative to the blade (e.g., blade 104), rocking the rocker away from the blade while actuating the rocker locking member, and removing the blade from a slot (e.g., 118) in the knife. Actuating the rocker locking member may comprise pushing the rocker locking member laterally and at least partially through the slot. For example, actuating the rocker locking member may comprise pushing a button or pin feature into the broad side or cheek of the knife. The method may also comprise inserting a second blade into the slot while rocking the rocker, rotating the rocker toward the second blade while actuating the rocker locking member, and deactuating the rocker locking member to lock the rocker relative to the second blade. In one example embodiment, the blade 104 may be removed from knife 100 and tool 500 may be inserted into the knife 100 in place of blade 104 by inserting the tool 500 into the slot 118 while rocking the rocker 310 and then rotating the rocker 310 toward the tool 500 while actuating the lock pin 322. The lock pin 322 may then be deactuated (i.e., released or let return to a rest or low-potential-energy position) to keep the rocker 310 in position to retain the tool 500. Accordingly, the knife may have interchangeable blades wherein the blades are removable and replaceable with other compatible blades or tools.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A knife having an interchangeable blade, the knife comprising:
a handle;
a latch assembly connected to the handle, the latch assembly comprising:
a slot;
a rocker positioned in the slot, the rocker being rotatable within the slot between a first rocker position and a second rocker position, the second rocker position being rotated relative to the first rocker position;
a rocker locking member extending across the slot, the rocker locking member being movable between a locked position preventing rotation of the rocker between the first and second rocker positions and an unlocked position permitting rotation of the rocker between the first and second rocker positions;
a blade comprising:
a proximal end positioned in the slot;
a back edge having a notch, the rocker being positioned in the notch when the rocker is in the first rocker position, the blade being prevented from removal from the slot when the rocker is in the first rocker position, the blade being removable from the slot when the rocker is in the second rocker position.

2. The knife of claim 1, wherein the latch assembly and the blade are foldable into the handle.

3. The knife of claim 1, wherein the rocker locking member is a button.

4. The knife of claim 1, wherein the rocker locking member is biased to the first rocker position by a compliant member.

5. The knife of claim 1, wherein the rocker locking member comprises a first diameter portion and a second diameter portion, the first diameter portion being aligned with the rocker in the slot when the rocker locking member is in the locked position, the second diameter portion being aligned with the rocker in the slot when the rocker locking member is in the unlocked position.

6. The knife of claim 5, wherein the first diameter portion has a greater diameter than the second diameter portion.

7. The knife of claim 1, wherein the rocker locking member is positioned on a thumbstud.

8. The knife of claim 1, wherein the rocker comprises a pivot point in the slot that is positioned distal to the rocker locking member.

9. The knife of claim 1, wherein the blade further comprises a longitudinally-extending notch and the latch assembly further comprises a retaining member in the slot, the retaining member being positioned in the longitudinally-extending notch of the blade.

10. The knife of claim 1, wherein the blade further comprises a hook portion and the latch assembly comprises a retention plate, the hook extending around at least two sides of the retention plate.

11. The knife of claim 1, wherein the proximal end of the blade has a trapezoidal shape and the latch assembly has a trapezoidal hollow, the trapezoidal shape being fitted into the trapezoidal hollow.

12. A knife having a removable blade and dual-stage locking mechanism, the knife comprising:
a handle;
a latch assembly connected to the handle, the latch assembly comprising a slot, a first latch, and a second latch, the first latch being translatable relative to the slot, the second latch being rotatable relative to the slot;
a blade retained in the slot, the blade being removable from the slot upon sequential actuation the first latch followed by the second latch.

13. The knife of claim 12, wherein the first latch locks a position of the second latch.

14. The knife of claim 12, wherein the second latch retains the blade in the slot.

15. The knife of claim 12, wherein the first latch is a biased pin extending through the slot.

16. The knife of claim 12, wherein the second latch is a rocker at least partially positioned in a notch in the blade.

17. A method of securing an interchangeable blade to a knife handle, the method comprising:
providing a knife, the knife having a handle, a latch assembly, and a blade, the latch assembly being connected to the handle, the latch assembly comprising a slot in which the blade is positioned, the latch assembly comprising a rocker and a rocker locking member, the rocker retaining the blade in the slot;
actuating the rocker locking member to unlock the rocker relative to the blade;
rocking the rocker away from the blade while actuating the rocker locking member;
removing the blade from the slot.

18. The method of claim 17, wherein actuating the rocker locking member comprises pushing the rocker locking member laterally and at least partially through the slot.

19. The method of claim 17, further comprising inserting a second blade into the slot while rocking the rocker, rotating the rocker toward the second blade while actuating the rocker locking member, and deactuating the rocker locking member to lock the rocker relative to the second blade.

20. An interchangeable blade for a knife, the interchangeable blade comprising:
a lateral face;
a belly edge;
a spine edge, the spine edge being positioned opposite the belly edge;
a first recess being recessed into the spine edge in a first direction;
a second recess being recessed into the spine edge in a second direction, the first direction being positioned non-parallel to the second direction.

21. The interchangeable blade of claim 20, wherein the first direction extends toward the belly edge.

22. The interchangeable blade of claim 20, further comprising a heel portion comprising a rear edge, the belly edge comprising a heel edge at the heel portion, the heel edge extending at an acute angle relative to the rear edge.

23. The interchangeable blade of claim 20, wherein the spine edge comprises a protrusion extending at least partially around the second recess.

24. The interchangeable blade of claim 20, wherein the second direction is parallel to a major longitudinal axis of the interchangeable blade.

25. The interchangeable blade of claim 20, wherein the first direction is perpendicular to the second direction.

26. The interchangeable blade of claim 20, wherein the belly edge comprises a sharpened gut hook blade.
